(19) United States
(12) Patent Application Publication
(10) Pub. No.: US 2012/0103957 A1
(43) Pub. Date: May 3, 2012

(54) METAL STUD FABRICATOR

(76) Inventor: John Powers, III, Phoenix, AZ (US)

(21) Appl. No.: 12/917,473

(22) Filed: Nov. 1, 2010

(51) Int. Cl. B23K 11/00; B21B 1/00

(52) U.S. Cl. 219/148; 72/203

(57) ABSTRACT

Metal stud manufacturing apparatus includes a plurality of metal shaping rollers positioned to shape and cut longitudinally a continuous metal strip into two spaced apart metal panels each having a turned longitudinal edge. A pair of opposed wire shaping elements are positioned to form a continuous wire into a continuous zig-zag pattern of wire. An assembly component receives the metal panels and the zig-zag pattern of wire and positions the wire between the panels and in contact with the turned edge of each of the panels to form a continuous beam assembly. A welding component receives the beam assembly and spot welds the wire to the turned edge of each panel to form a continuous fixed beam. A cutting component is reciprocally mounted to receive the continuous fixed beam and to hold and shear the beam at a selected area to form a plurality of separate metal beams of a desired length.

### FIELD OF THE INVENTION

This invention generally relates to apparatus for manufacturing metal studs for the building industry.

### BACKGROUND OF THE INVENTION

Studs, joists, beams, rafters, etc. are terms used to describe various framing and support components in the building industry. For purposes of simplification and better understanding, the term “stud” or “studs” will be used generically in this disclosure to represent any framing or support component. Specifically, a metal stud of the type being manufactured is disclosed in a copending United States patent application entitled “Metal Stud”, filed 21 Nov. 2008, bearing Ser. No. 12/275,914, and incorporated herein by reference.

The metal stud of the type disclosed in the copending application can be relatively difficult to manufacture. The various components must be fabricated and assembled, preferably with a minimum amount of labor and effort on the part of workmen. The present fabricator or manufacturing system produces a complete metal stud from raw materials with substantially no intervention by workmen. Further, the manufacturing system is a continuous process so that complete metal studs are manufactured continuously until the raw materials are depleted.

Accordingly, it is an object of the present invention to provide new and improved manufacturing apparatus for producing metal studs.

It is another object of the present invention to provide new and improved manufacturing apparatus for producing metal studs that are complete and consistent.

It is another object of the present invention to provide a new and improved manufacturing apparatus for producing metal studs that is easy to use and requires relatively little intervention by workmen.

### SUMMARY OF THE INVENTION

Briefly, to achieve the desired objects of the instant invention in accordance with a preferred embodiment thereof, metal stud manufacturing apparatus is disclosed that includes a plurality of metal shaping rollers positioned to shape a continuous metal strip into continuous first and second spaced apart metal panels each having first and second longitudinal edges turned to provide support along the longitudinal axis. A pair of opposed wire shaping elements are positioned to form a continuous wire into a continuous zig-zag pattern of wire. An assembly component is positioned to receive the continuous first and second spaced apart metal panels and the continuous zig-zag pattern of wire and to position the zig-zag pattern of wire between the spaced apart metal panels and in contact with one of the first and second longitudinal edges of each of the spaced apart metal panels to form a continuous beam assembly. A welding component receives the continuous beam assembly and spot welds the zig-zag pattern of wire to the one of the first and second longitudinal edges of each of the spaced apart metal panels to form a continuous fixed beam. A cutting component is reciprocally mounted to receive the continuous fixed beam and to hold the continuous fixed beam at selected areas and to shear the continuous fixed beam at the selected areas to form a plurality of separate metal beams of a desired length.

The desired objects of the instant invention are further achieved in accordance with a specific embodiment thereof in which a metal stud manufacturing apparatus includes a source of a continuous metal strip and a source of a continuous wire. A plurality of metal shaping rollers are positioned to receive the continuous metal strip from the source and to shape the continuous metal strip into continuous first and second spaced apart metal panels each having first and second longitudinal edges turned to provide support along the longitudinal axis. The plurality of metal shaping rollers shape the first and second spaced apart metal panels to each include an outwardly directed flat surface, and shape each first and second longitudinal edge turned to provide support of each first and second spaced apart metal panel to include at least one bend away from the outwardly directed flat surface, and the plurality of metal shaping rollers also provide a knurled surface on each of the outwardly directed flat surfaces of the first and second spaced apart metal panels. A wire straightening element is positioned to receive the continuous wire from the source and includes a first plurality of rollers oriented in the horizontal plane to straighten out any bends in the wire parallel with the horizontal plane and a second plurality of rollers oriented in the vertical plane to straighten out any bends in the wire parallel with the vertical plane. A pair of opposing wire shaping elements are positioned to receive the straightened continuous wire from the wire straightening element and to form the straightened continuous wire into a continuous zig-zag pattern of wire. The zig-zag pattern of wire forms an angular metal coupling element positionable between the first and second spaced apart metal panels and bent to periodically and alternately contact the first and second spaced apart metal panels at contact points. An assembly component positioned to receive the continuous first and second spaced apart metal panels and the continuous zig-zag pattern of wire and to position the zig-zag pattern of wire between the spaced apart metal panels and in contact with one of the first and second longitudinal edges of each of the spaced apart metal panels to form a continuous beam assembly. A welding component receives the continuous beam assembly and spot welds the zig-zag pattern of wire to the one of the first and second longitudinal edges of each of the spaced apart metal panels to form a continuous fixed beam. A cutting component is reciprocally mounted to receive the continuous fixed beam and to hold the continuous fixed beam at selected areas and to shear the continuous fixed beam at the selected areas to form a plurality of separate metal beams of a desired length. The apparatus is designed to continuously move the continuous metal strip and the continuous wire through the apparatus at a continuous and fixed speed, and the cutting component is designed to reciprocally move with the continuous fixed beam at the fixed speed to perform the shear cutting at a selected cutting area and after the shear cutting reciprocate to the next cutting area.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a side view of the manufacturing apparatus for producing metal studs in accordance with the present invention;

FIG. 2 is a top view of the manufacturing apparatus of FIG. 1;

FIGS. 3 and 4 are side and top views, respectively, of a metal feeding component of the manufacturing apparatus of FIG. 1;

FIGS. 5 and 6 are side and top views, respectively, of a wire feeding component of the manufacturing apparatus of FIG. 1;

FIG. 7 is a side view of a wire shaping component of the manufacturing apparatus of FIG. 1;

FIGS. 7a and 7b are enlarged perspective views of a wire straightening element of the wire shaping component of FIG. 7;

FIG. 8 is a top view of the wire shaping component of FIG. 7;

FIGS. 9 and 10 are side and top views, respectively, of a metal shaping and cutting component of the manufacturing apparatus of FIG. 1;

FIGS. 10a through 10f are enlarged perspective views of some of the elements of the metal shaping and cutting component of FIG. 10;

FIGS. 11 and 12 are side and top views, respectively, of a partial assembling and/or positioning component of the manufacturing apparatus of FIG. 1;

FIG. 13 is a side view of a spot welding component of the manufacturing apparatus of FIG. 1;

FIGS. 14 and 15 are side and top views, respectively, of a cutting component of the manufacturing apparatus of FIG. 1;

FIGS. 16 and 17 are side and top views, respectively, of a control panel component of the manufacturing apparatus of FIG. 1;

FIGS. 18 and 19 are side and top views, respectively, of an end product removal component of the manufacturing apparatus of FIG. 1;

FIGS. 20 and 21 are side and top views, respectively, of a receiving table component of the manufacturing apparatus of FIG. 1;

FIG. 22 is a side view in perspective of a partial metal stud produced by the manufacturing apparatus of FIG. 1; and

FIG. 23 is an end view of the metal stud illustrated in FIG. 20.

### DETAILED DESCRIPTION OF A PREFERRED EMBODIMENT

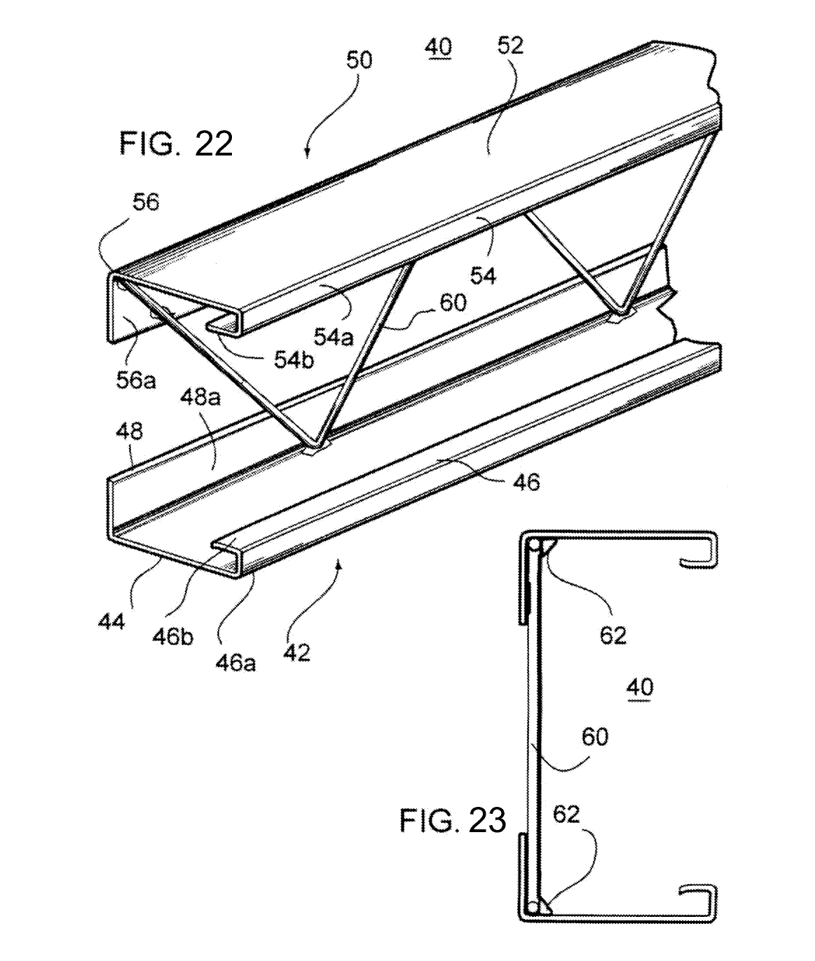

Turning first to FIGS. 22 and 23, a complete metal stud 40 produced by the manufacturing apparatus of the present invention is illustrated. Metal stud 40 includes a lower panel 42 forming a lower flat stud surface 44 with one edge 46 turned upwardly at 46a and inwardly at 46b, for the length of lower panel 42. Also, lower panel 42 of metal stud 40 includes an opposing edge 48 turned upwardly at 48a a distance greater than the width of portion 46a (and in this specific embodiment a distance approximately equal to the combined widths of portions 46a and 46b), for the length of lower panel 42. For convenience portion 48a of lower panel 42 is referred to as a side wall herein.

Metal stud 40 also includes an upper panel 50 forming an upper flat stud surface 52 with one edge 54 turned downwardly at 54a and inwardly at 54b, for the length of panel 50. Also, upper panel 50 of metal stud 40 includes an opposing edge 56 turned downwardly at 56a a distance greater than the width of portion 46a (and in this specific embodiment a distance approximately equal to the combined widths of portions 54a and 54b), for the length of upper panel 50. For convenience portion 56a of upper panel 50 is referred to as a side wall herein.

Lower panel 42 and upper panel 50 are positioned in parallel spaced apart relationship with lower stud surface 44 directed downwardly and upper stud surface 52 directed upwardly. An angular coupling element 60 extends between lower panel 42 and upper panel 50 and is bent periodically at some predetermined angle, generally between 30° and 90°, so as to alternately contact the inner surface of lower panel 42 and the inner surface of upper panel 50 at regular intervals (e.g. six inches). In this embodiment coupling element 60 is positioned adjacent turned-up edge 48a of lower panel 42 and turned-down edge 56a of upper panel 50.

Generally, coupling element 60 is a single continuous length of some relatively heavy gauge wire (e.g. 0.100″ to 0.200″ thick) that is bent or formed to provide desired contact points 62 with the inner surfaces of lower panel 42 and upper panel 50. Also, in this embodiment each span of coupling element 60 is affixed to the inner surface of adjacent turned-up edge 48a of lower panel 42 or turned-down edge 56a of upper panel 50. In this preferred embodiment coupling element 60 is affixed to the adjacent surfaces of edges 48a and 56a by some convenient method such as spot welding or the like. Fixing coupling element 60 to adjacent turned-up edge 48a and turned-down edge 56a adds strength and extra support to coupling element 60 for horizontal building components requiring more transverse (vertical) pressure along the span.

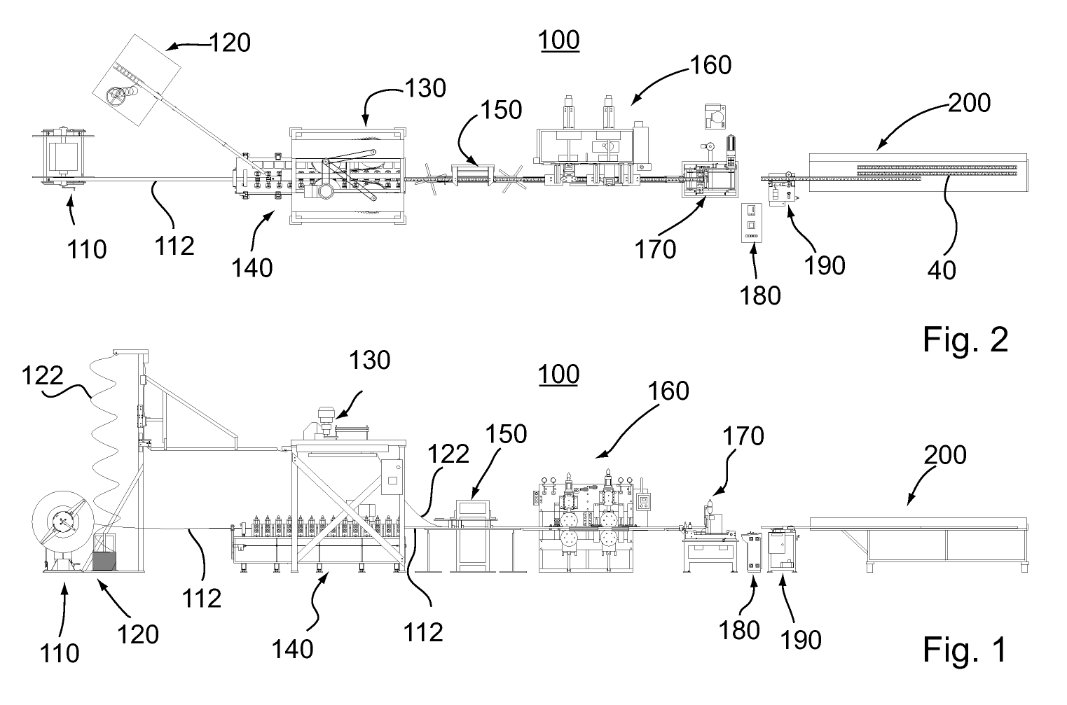

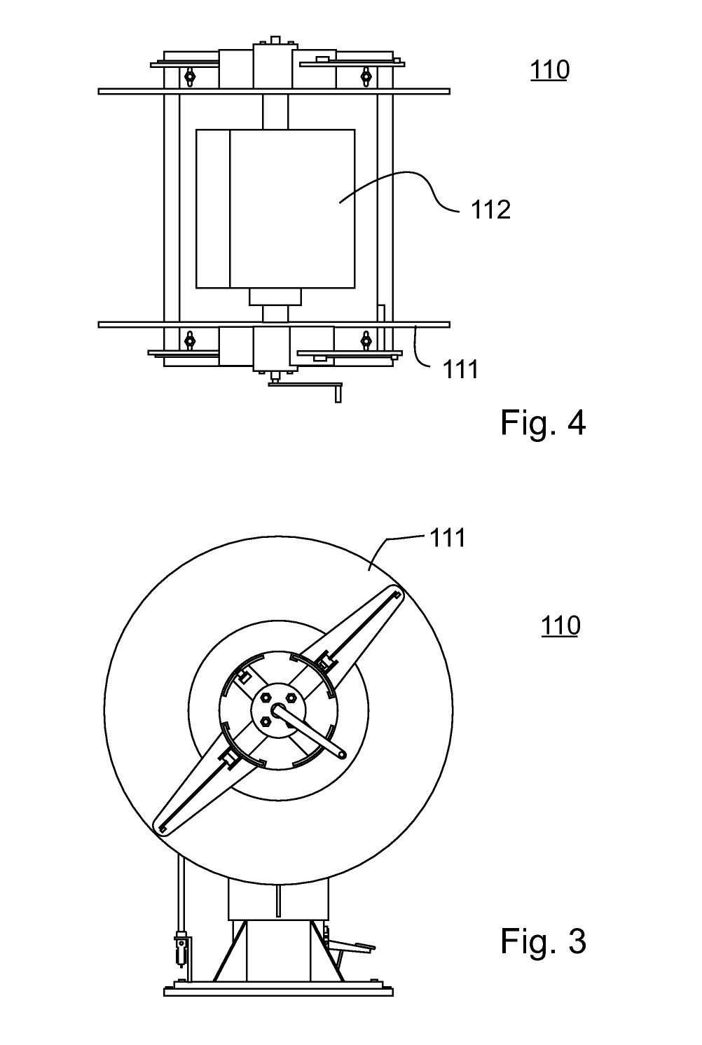

Turning now to FIGS. 1 and 2, manufacturing apparatus, generally designated 100, for producing metal studs in accordance with the present invention is illustrated. Apparatus 100 includes a metal feeding component 110, a wire feeding component 120, a wire shaping component 130, a metal shaping component 140, a partial assembling and/or positioning component 150, a spot welding component 160, a shear cutting component 170, a control panel 180, an end product removal component 190, and a receiving table 200. Each of the listed components is shown and described in more detail in FIGS. 3-21.

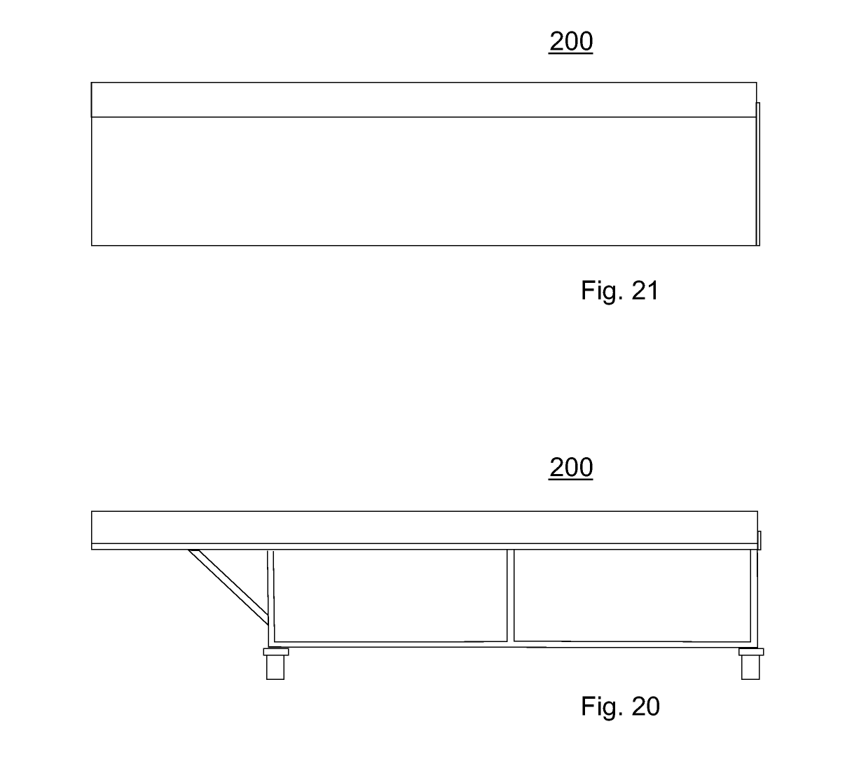

Referring additionally to FIGS. 3 and 4, metal feeding component 110 is illustrated in more detail. Basically, component 110 is a large drum or spool 111 carrying an elongated continuous metal strip 112, which is formed into lower panel 42 and upper panel 50 of metal stud 40 (see FIG. 20). Generally, metal strip 112 can include any convenient metal material, such as a relatively heavy gauge sheet metal (e.g. 16 gauge to 25 gauge) with the specific metal selected for any specific metal beam application. For example in metal beam applications requiring substantial support the sheet metal selected might be sheet steel while in applications requiring less support but where weight might be a consideration sheet aluminum might be used.

Elongated continuous metal strip 112 has a width approximately equal to the entire width of lower panel 42, including flat stud surface 44, edge 46 turned upwardly at 46a and inwardly at 46b, and opposing edge 48, plus the entire width of upper panel 50, including flat stud surface 52, edge 54 turned downwardly at 54a and inwardly at 54b, and opposing edge 56. To place this measurement in context and assuming (for example only) metal stud 40 is a 2×4, stud surfaces 44 and 52 are each approximately 2 inches wide, edges 48 and 56 are each approximately 1 inch wide, and the combined width of portions 46a/46b and 54a/54b are each approximately 1 inch. Thus, to produce this metal stud the total width of metal strip 112 would be approximately 8 inches. As can be seen in FIG. 1, metal strip 112 is supplied continuously to metal shaping component 140.

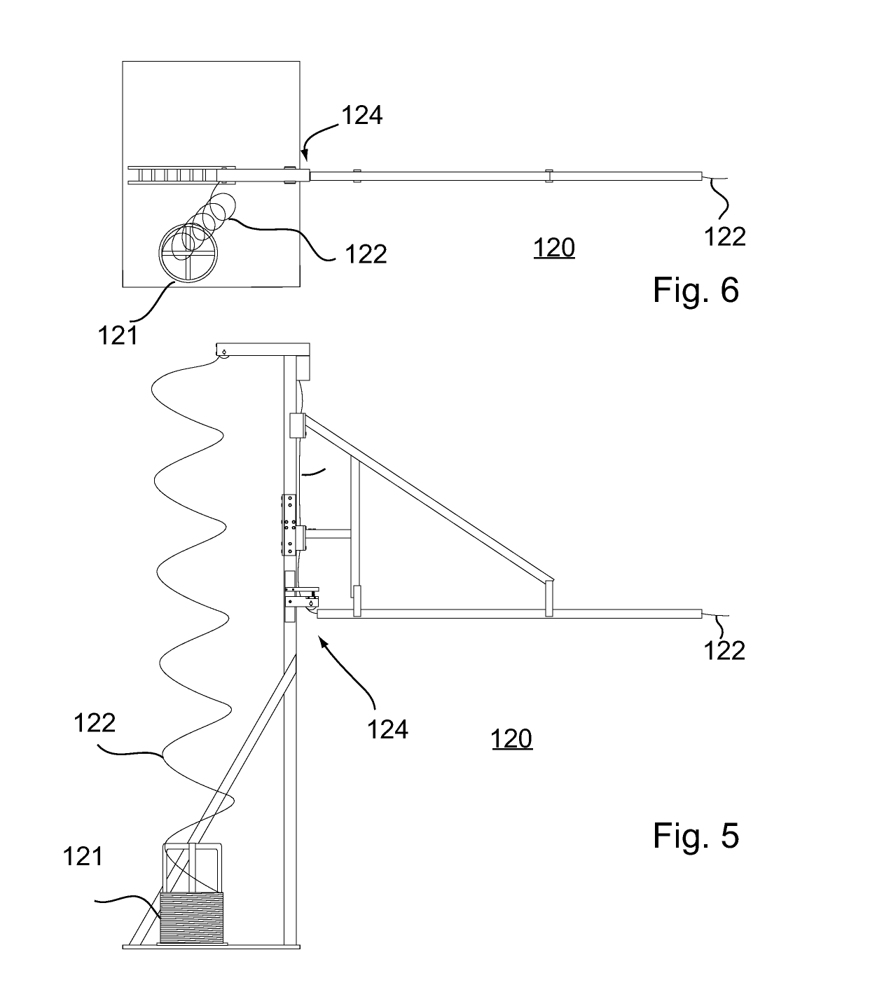

Turning next to FIGS. 5 and 6, wire feeding component 120 is illustrated in more detail. Component 120 includes a roll or spool 121 of continuous wire 122. As explained above, wire 122 is a single continuous length of some relatively heavy gauge wire (e.g. 0.100″ to 0.200″ thick). Wire 122 extends upwardly and is guided and partially straightened by a tower generally designated 124. Optional elongated struts (not shown) may be used to guide wire 122 from spool 121 to tower 124 so as to prevent the loops from becoming entangled with each other. Tower 124 guides continuous wire 122 into wire shaping component 130, as can be seen in FIG. 1. Tower 124 is designed to produce some tension in continuous wire 122 as wire 122 is drawn into wire shaping component 130 and to simultaneously begin the straightening process. Since wire 122 is originally wound on roll or spool 121, there is a strong tendency for the wire to coil into loops. Tower 124 provides a tension in wire 122 that begins the process of straightening wire 122 into a continuous straight form.

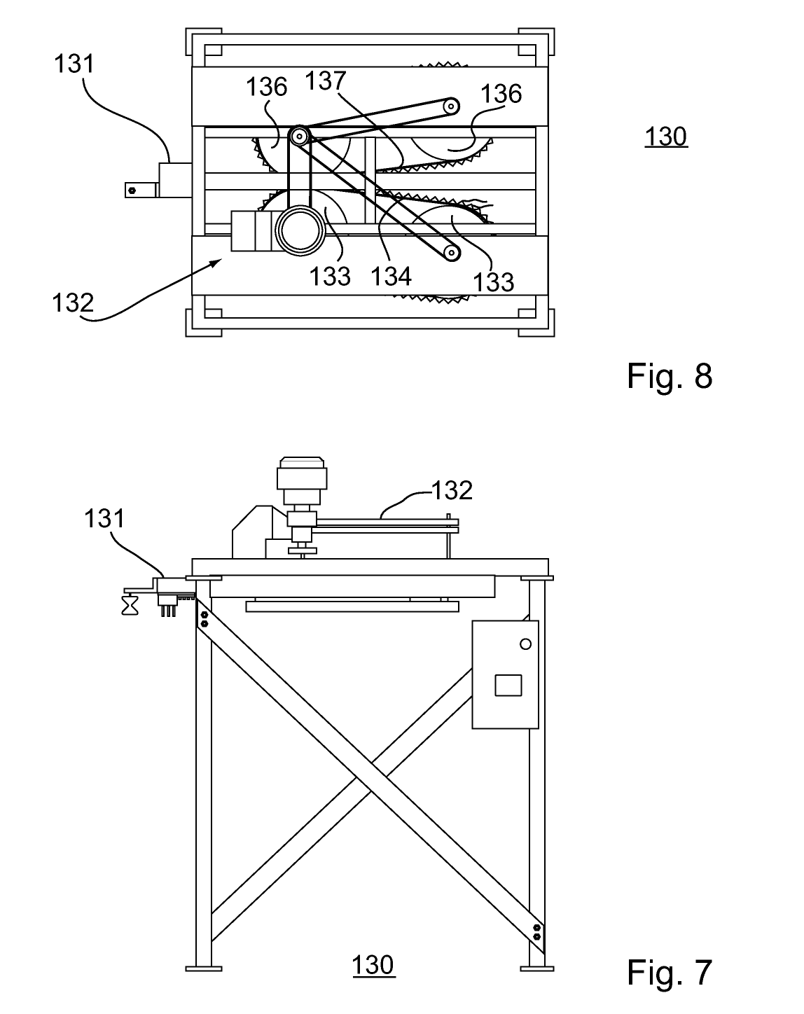

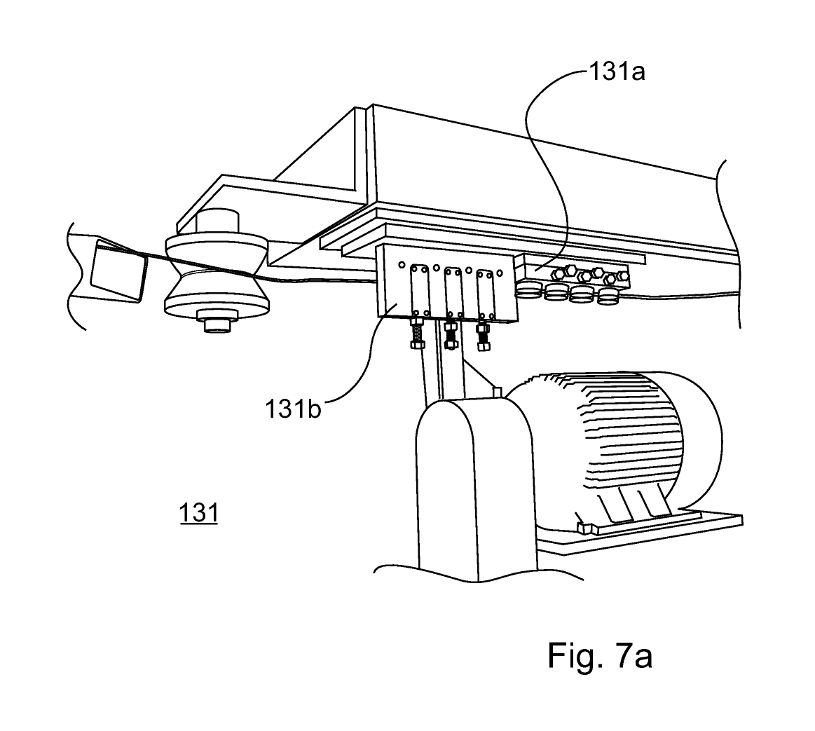

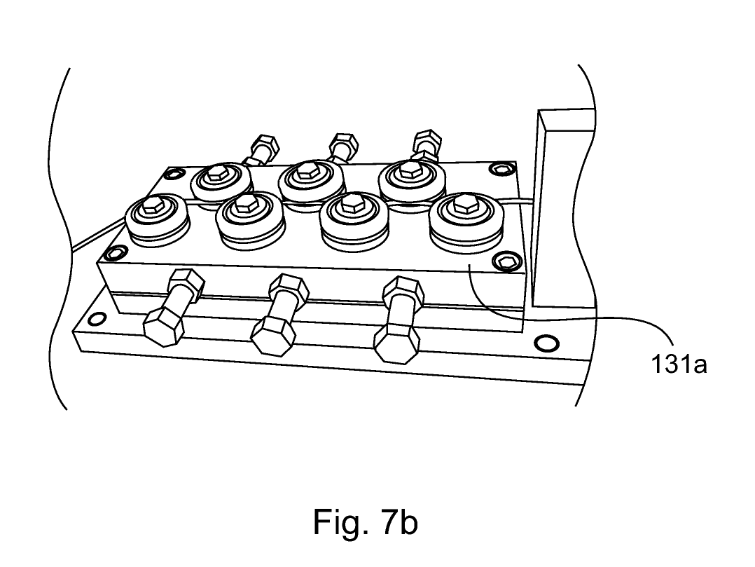

Referring to FIG. 7 wire shaping component 130 is illustrated in more detail. Wire shaping component 130 includes a wire straightening element 131 that receives wire 122 directly from tower 124. As illustrated in F more detail in FIGS. 7a and 7b, wire straightening element 131 includes a plurality of rollers 131a oriented in the horizontal plane to straighten out any bends in wire 122 parallel with the horizontal plane. Also, wire straightening element 131 includes a plurality of rollers 131b oriented in the vertical plane to straighten out any bends in wire 122 parallel with the vertical plane. As wire 122 leaves wire straightening element 131, wire 122 is completely straight, i.e. it extends along a single continuous axis.

Wire 122 exiting wire straightening element 131 enters a wire shaping element 132. Wire shaping element 132 includes a plurality of sprockets with driven chains extending around opposing pairs. Referring additionally to FIG. 8 a top view of the sprockets and chains is illustrated in more detail. Two spaced apart sprockets 133 drive a chain 134 having generally wedge shaped teeth 135 extending radially outwardly therefrom. Two opposing spaced apart sprockets 136 drive a chain 137 having generally wedge shaped teeth 138 extending radially outwardly therefrom. As sprockets 133 and 136 rotate chains 134 and 137, teeth 135 and 138 mesh in a loose fashion to form wire 122 into a continuous zig-zag pattern to ultimately form coupling element 60 of FIG. 22.

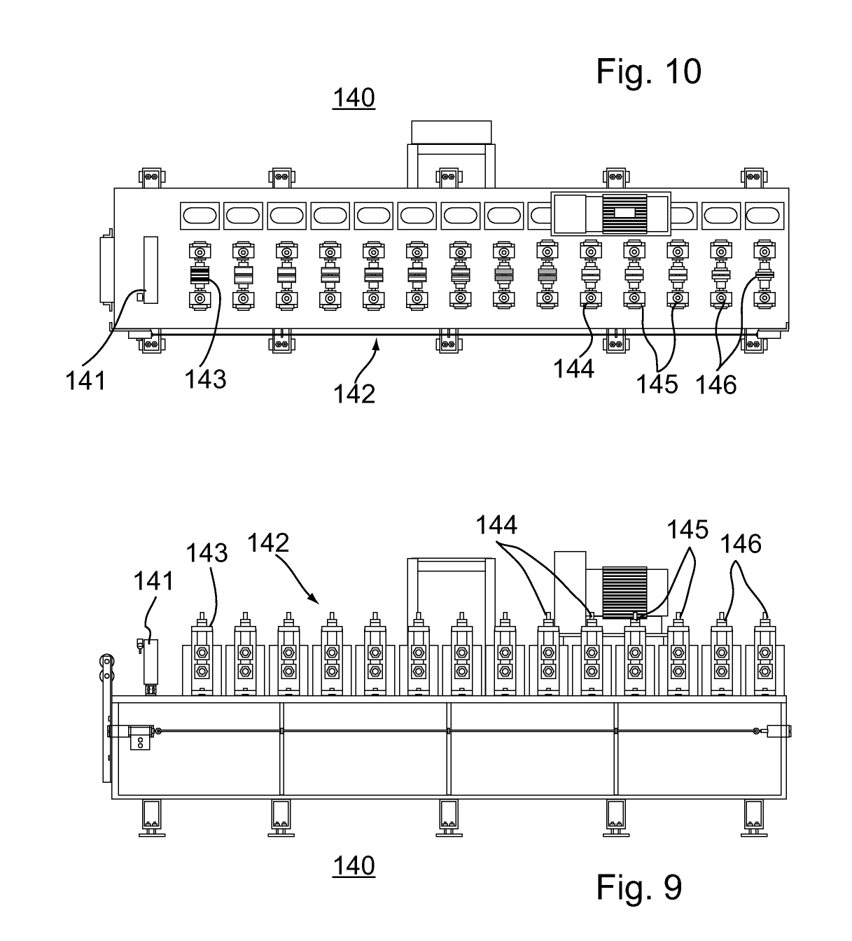

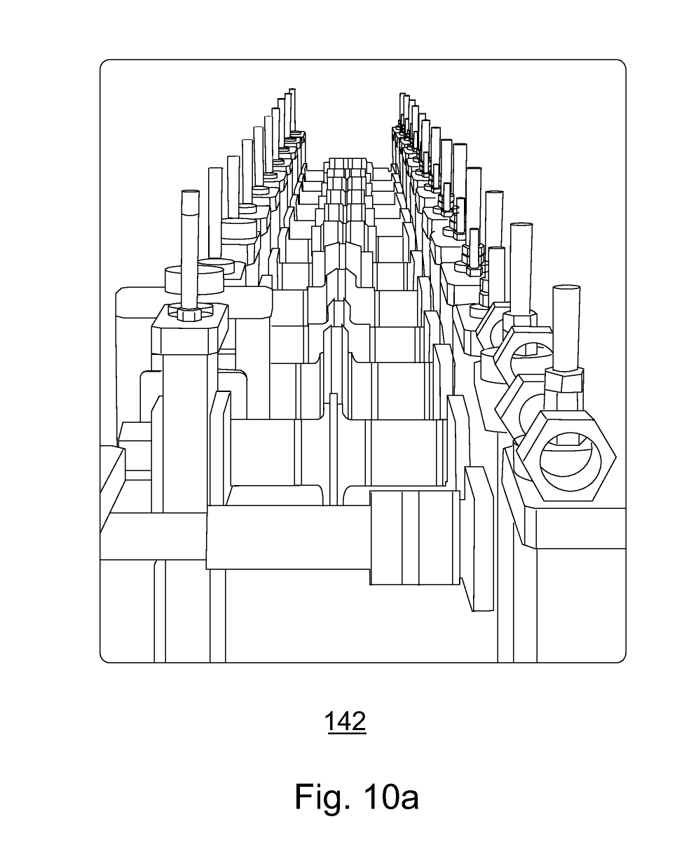

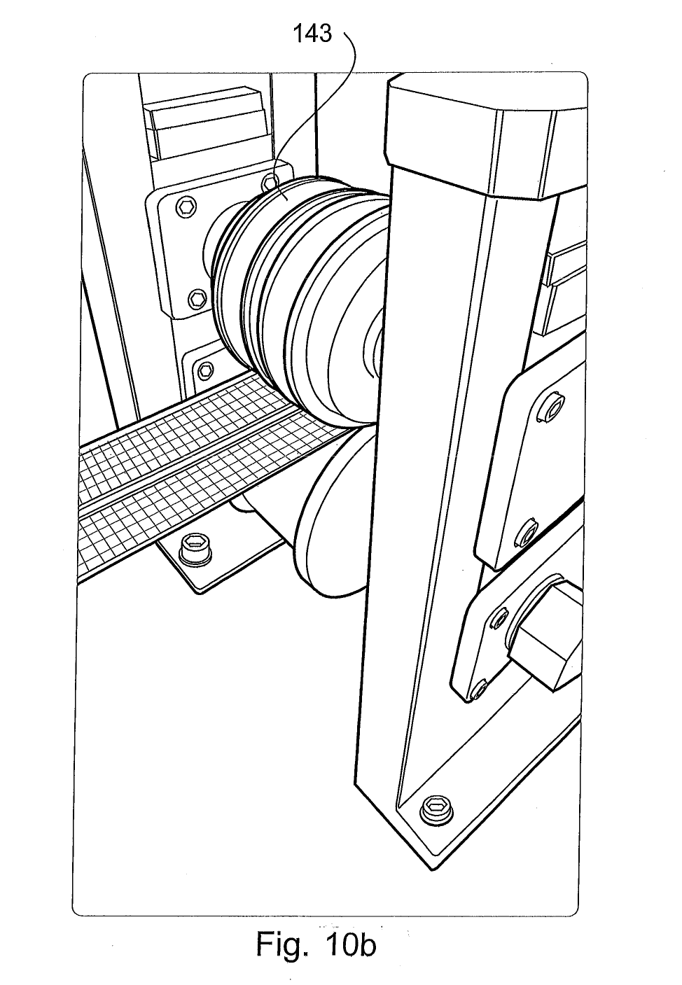

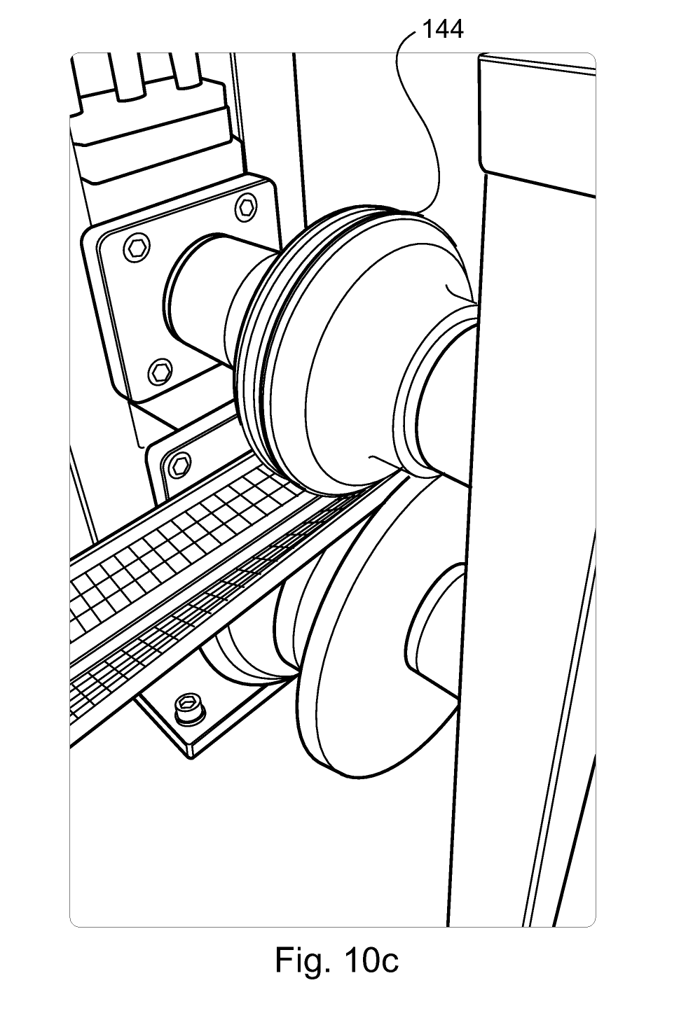

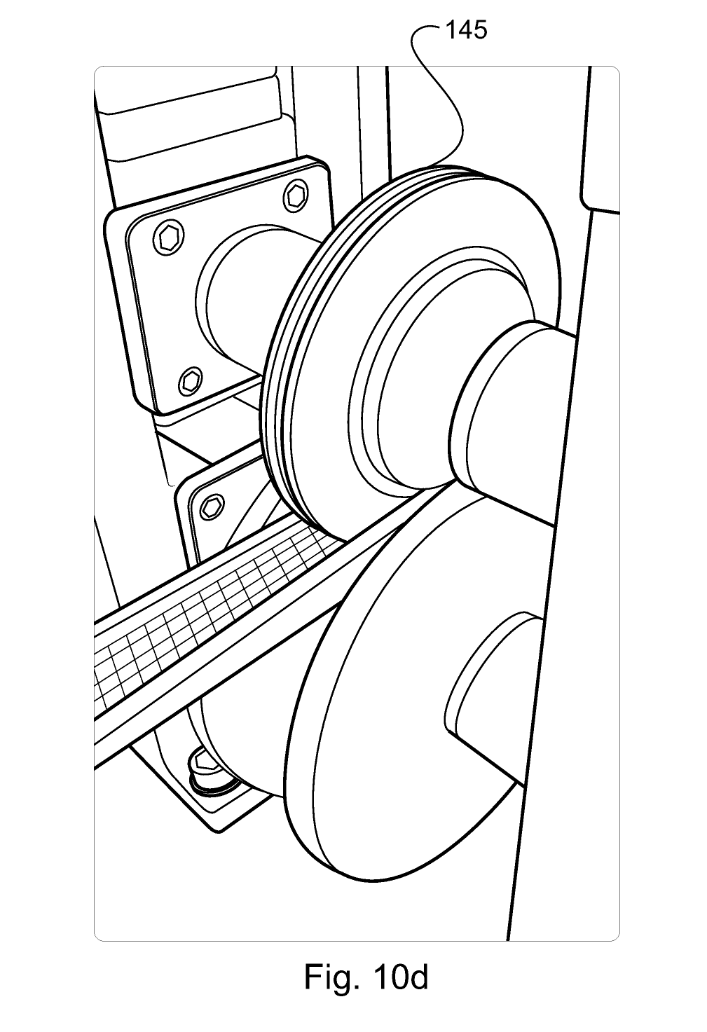

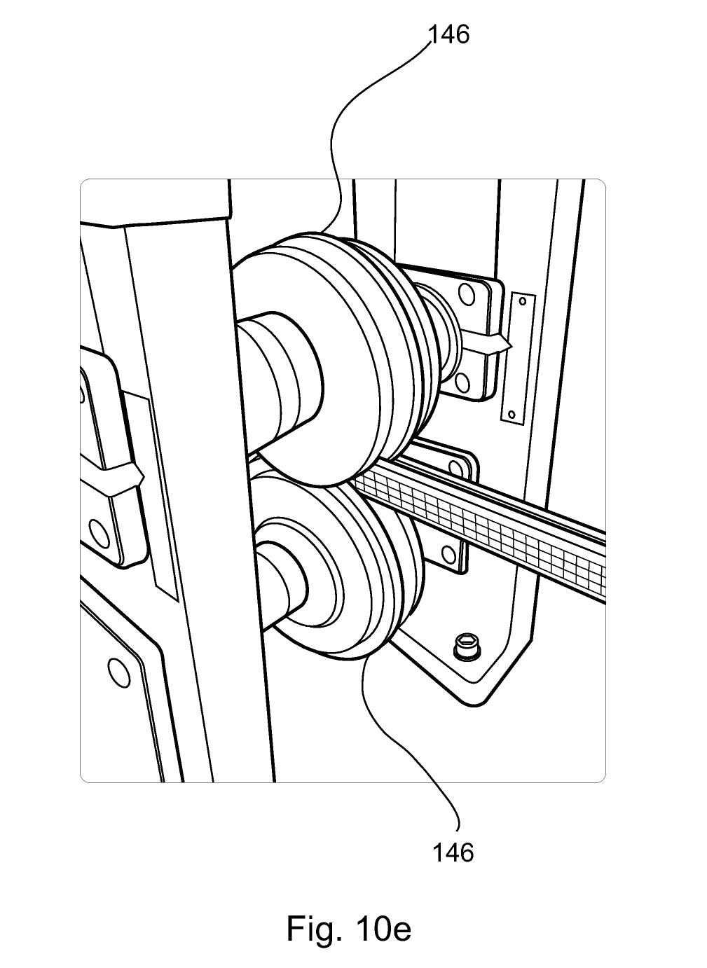

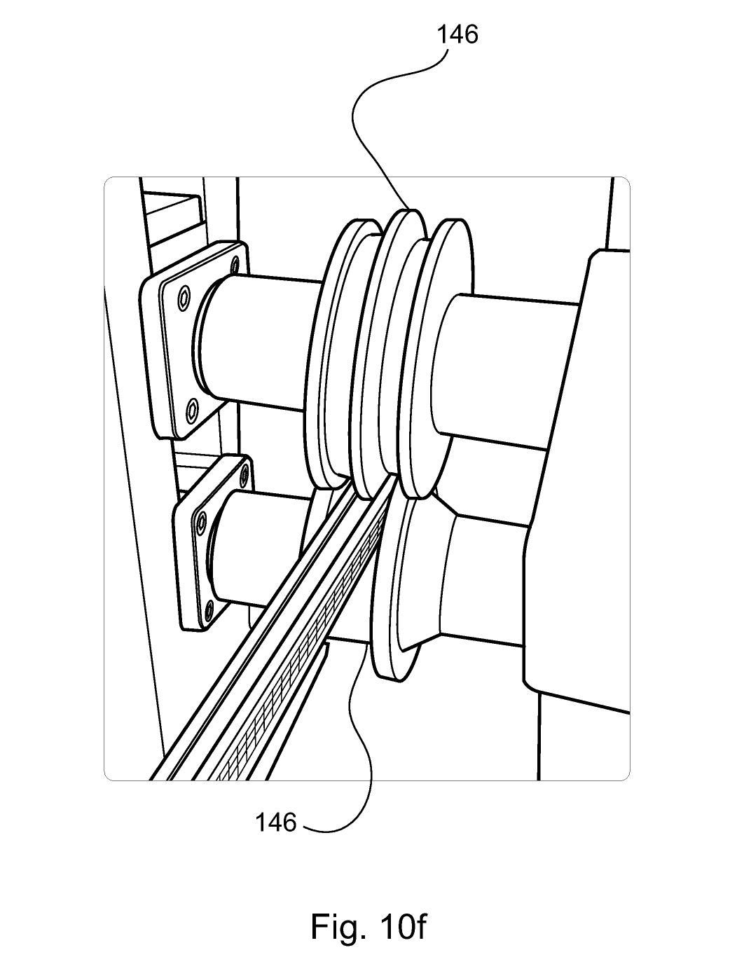

Referring now to FIGS. 9 and 10, metal shaping component 140 is illustrated in more detail. Component 140 includes a first metal guide that receives flat continuous sheet metal strip 112 from spool 111 and guides strip 112 into a series of rollers 142 (in this example 14 sets of rollers although more or less rollers might be utilized if desired). An enlarged perspective view of rollers 142 is illustrated in FIG. 10a. A first set of rollers 143, also illustrated in perspective in FIG. 10b, produces two spaced apart (but still in a single strip) knurled or stippled surfaces in areas that will ultimately become flat stud surfaces 44 and 52 of metal beam 40. The knurled or stippled surfaces are optional but it is believed that the multiple small depressions in which the metal is slightly stretched or deformed produce an enhanced environment for the insertion of screws, nails, etc. when metal beam 40 is incorporated into a building or the like.

As flat continuous sheet metal strip 112 continues through series of rollers 142 the opposed outer edges are gradually rolled to produce the first edges 46a and 54a and ultimately the second rolled edges 46b and 54b. During the same time a central area of continuous sheet metal strip 112 is gradually bent to form edges 48 and 56. As flat continuous sheet metal strip 112 reaches a last series of rollers, designated 144-146, the opposed portions of strip 112, which will ultimately become lower panel 42 and upper panel 50 (see FIG. 20) are gradually positioned in a facing orientation (see FIGS. 10c-10f) and are separated or cut by opposing rollers 146 into the two panels. In this facing orientation the two panels are further oriented with the flat perpendicular edges 48 and 56 at a lower position with the flat stud surfaces 44 and 52 extending vertically upward therefrom.

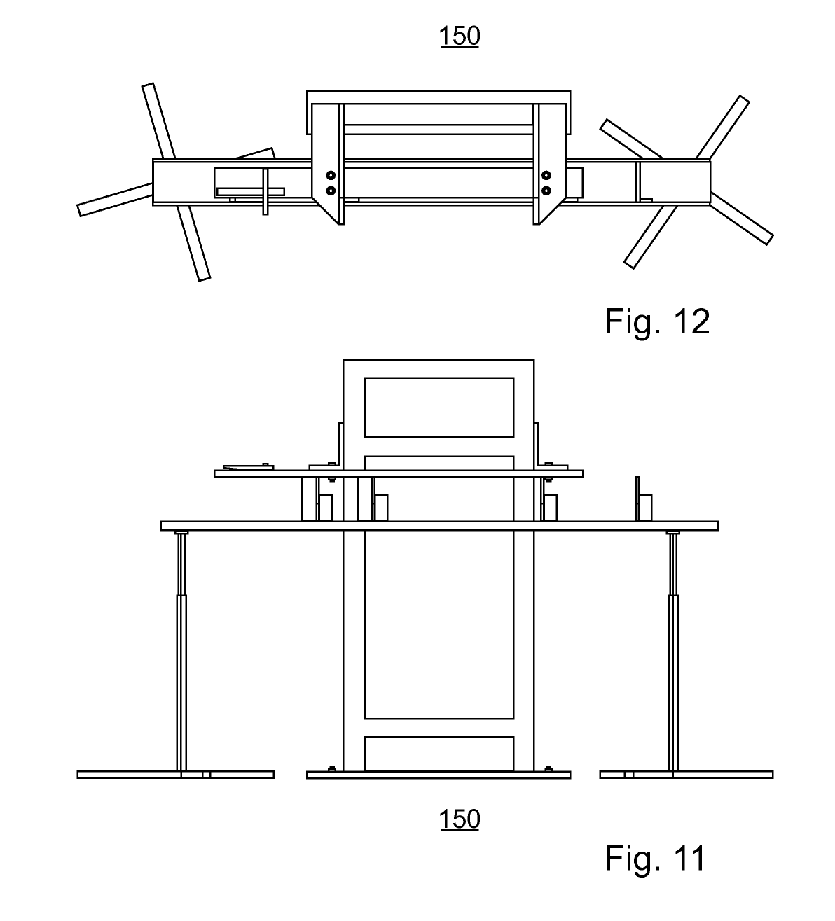

Referring additionally to FIGS. 11 and 12, partial assembling and/or positioning component 150 is illustrated in more detail. In component 150, the two separated and facing panels from metal shaping component 140 are positioned in a spaced apart orientation (generally simply separated the desired distance) and wire 122 (now in the zig-zag form) from wire shaping component 130 is positioned between the separated panels. At this point wire 122 in the zig-zag form is lying on the inner surfaces of edges 48 and 56 and butting against the inner surfaces of flat stud surfaces 44 and 52 (i.e. generally as illustrated in FIG. 22 but rotated counterclockwise ninety degrees). At this point it should be noted that sheet metal strip 112 and wire 122 are still in a continuous form and are traveling through apparatus 100 at a constant speed.

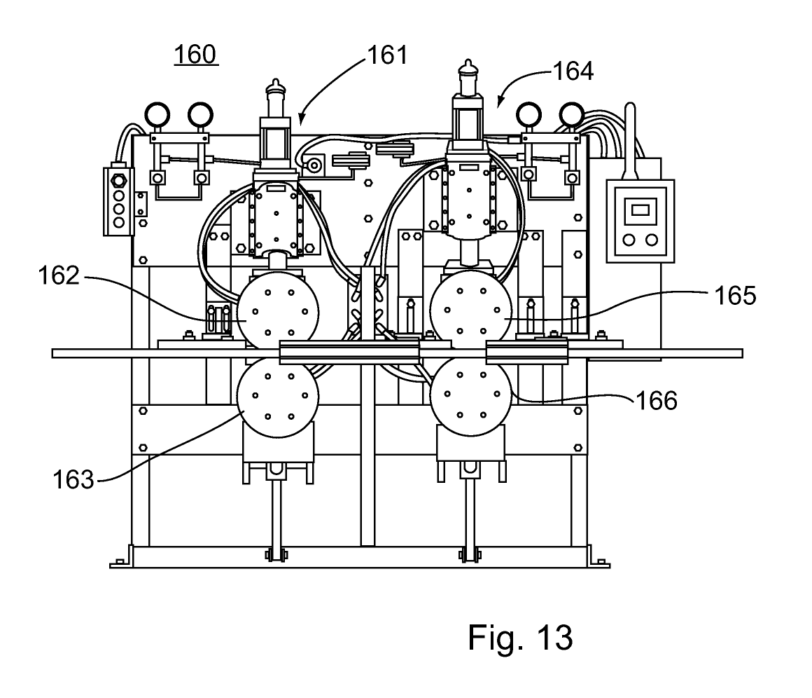

Turning now to FIG. 13, spot welding component 160 is illustrated in more detail. Sheet metal strip 112 and wire 122 in the form and orientation described above with reference to component 150 is introduced from component 150 into spot welding component 160 and held in this orientation by various fixed supporting members. Spot welding component 160 includes a first welding element 161 with a pair of opposed welding members, in this example wheels 162 and 163, and a second welding element 164 with a pair of opposed welding members, in this example wheels 165 and 166. In this example all four wheels 162, 163, 165, and 166 are formed of copper or some good electrical conductor. Wheel 163 of welding element 161 is positioned in constant electrical engagement with the lower surface of either edge 48 or edge 56 and wheel 166 is positioned in constant electrical engagement with the lower surface of the other edge 48 or edge 56. Wheels 162 and 165 are oriented at opposed angles to the vertical (i.e. one is angled into the plane of FIG. 13 and the other is angled out of the plane of FIG. 13) and are positioned between the spaced apart vertically oriented panels (i.e. continuous metal 112) so as to be in electrical contact with the wire 122 positioned on upper surfaces of either edge 48 or edge 56 and in an opposed relationship with lower wheels 163 and 166.

Since edges 48 and 56 (i.e. metal 122) are tangential to wheels 162, 163, 165, and 166, a point or short line electrical contact is formed with wire 122 on the upper surfaces of edges 48 and 56 and the lower surfaces of edges 48 and 56. To perform the spot welding process, a pulse of electrical current is applied between wheels 162 and 163 and between wheels 165 and 166 at substantially the exact moment that the upper wheels (162 and 165) are in contact with wire 122. Since metal 112 and wire 122 are traveling through apparatus 100 at a continuous and steady speed and since wire 122 is formed in a zig-zag pattern with the tips of the bends separated horizontally at a known and fixed distance, the timing of the electrical pulses supplied to the welding members can be very accurate. Further, it should be clear that the speed with which metal 112 and wire 122 travel through apparatus 100 and the distance between the tips of the bends in wire 122 can be varied to produce different configurations of metal beam 40 if desired.

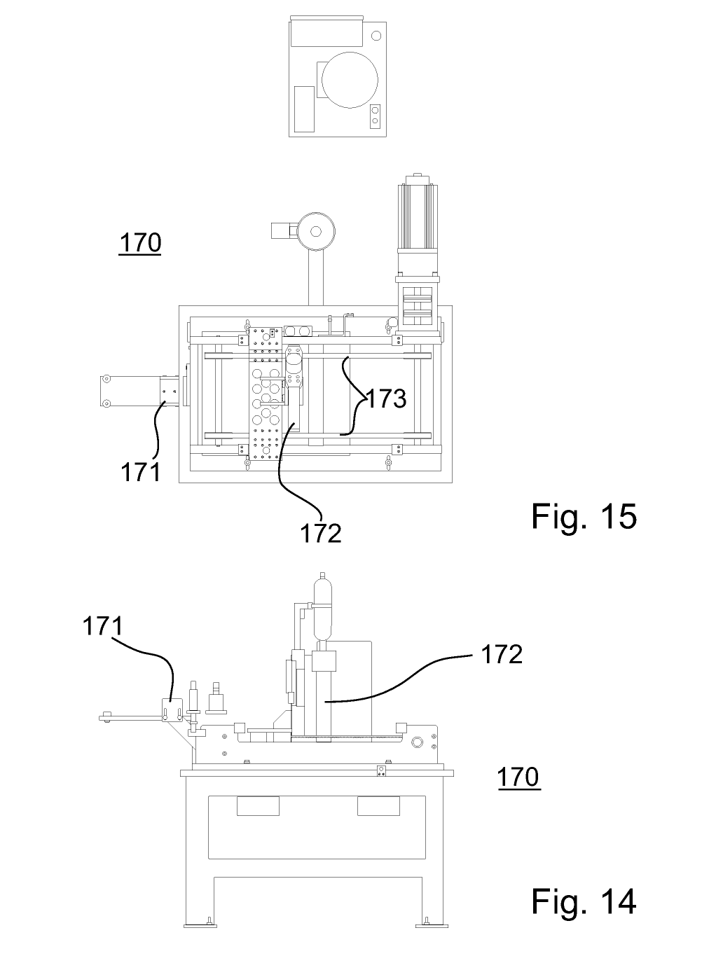

Referring now to FIGS. 14 and 15, a cutting component 170 is illustrated in more detail. Cutting component 170 receives the assembled and welded metal 112 and wire 122 in a guide 171 from welding component 160. A cutting element 172 is movably mounted on a pair of spaced apart tracks 173 for reciprocal movement in a horizontal direction parallel to the continuous movement of the assembled and welded metal 112 and wire 122. Cutting element 172 includes a form or housing that surrounds and supports assembled metal 112. Cutting element 172 also includes a reciprocating knife-like element that moves at an angle to assembled metal 112 (similar to one blade of a scissors). The combination of the form or housing and the reciprocating knife-like element provide a shear cutting operation that smoothly and cleanly separates the continuously moving assembled metal 112 and wire 122 into metal beams 40 of a desired length. Because the assembled metal 112 and wire 122 is moving continuously at a constant speed, cutting element 172 moves with assembled metal 112 and wire 122 and at the same speed along tracks 173 (toward the right in FIGS. 14 and 15) until the cutting process is completed, after which cutting element 172 returns to the starting position (at the left of tracks 173 in FIGS. 14 and 15) and is readied for the next cut.

The movement and cutting process of cutting element 172 is preferably controlled to cut assembled and welded metal 112 and wire 122 at one of the tips of the zig-zag pattern of wire 122. It is generally preferable to supply metal beams 40 in a standard length (e.g. 8 foot, 10 foot, 16 foot, etc.). This also dictates that the angle of the bends or the distance between tips of the bends formed in the zig-zag pattern are selected to result in a tip being positioned at each metal beam length selected. This requirement is easily achieved since any number with a multiple that results in twelve can be selected, e.g. 3, 4, 6, etc.

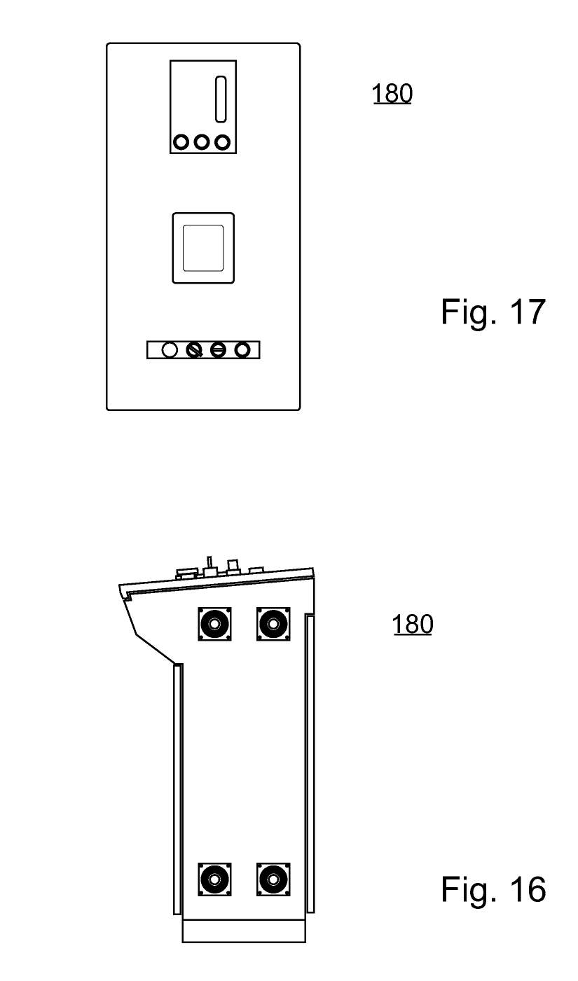

It is apparent from the above discussion that control of the process can be achieved through some central control system. Referring additionally to FIGS. 16 and 17, a control panel 180 is illustrated in more detail. In the present apparatus 10 control is achieved by control panel 180 that is electrically (and hydraulically if hydraulics are used) connected to all of the various components described above. In this preferred embodiment control panel 180 is used to set the speed of the continuous movement, the cutting lengths of beams, and the timing of pulses of welding current supplied to welding component 160 as well as any other variables that might be incorporated.

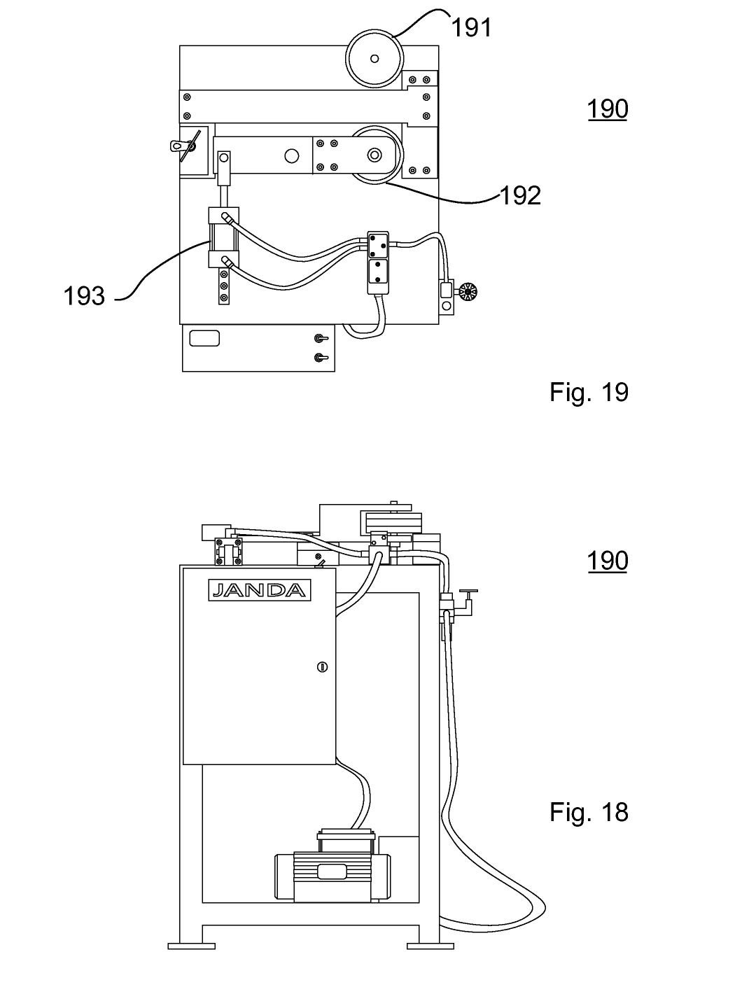

Referring to FIGS. 18 and 19 an end product removal component 190 is illustrated in more detail. As the separated and finished beams 40 exit the left end of cutting component 170, the finished beams arrive on the upper surface of component 190. A pair of opposed friction wheels 191 and 192 are positioned to grip the finished beams and move them to a receiving table 200, illustrated in detail in FIGS. 20 and 21. Friction wheels 191 and 192 are preferably a soft pliable material that frictionally engages the outer surface of the finished beam and moves it onto receiving table 200 for packaging etc. In this embodiment wheel 192 is biased inwardly toward wheel 191 by the action of a cylinder 193 to ensure a firm frictional engagement between wheels 191 and 192 with finished beams 40 for positive movement of the finished beams away from the continuously moving portions of apparatus 10. As will be understood by the skilled artisan, table 200 can be conveniently used for stacking, packaging etc. the completed beams 40 into any desired arrangement for shipping or further use or processing.

Thus, it will be understood that the new and improved metal stud manufacturing apparatus is relatively easy to use. Further in this apparatus the spaced apart panels are formed by simple bending and separating a continuous role of metal. The coupling element of the beams is also simple to form from a continuous roll of wire. Connecting the coupling element to the spaced apart panels is accomplished by the machine designed to provide the spot welds at regular intervals. Also, the cutting component is designed to operate with the continuously moving assembly of metal and wires so that no stopping or hesitations are inherent in the system. Therefore, new and improved metal stud manufacturing apparatus is disclosed that is constructed to form consistent and reliable metal studs of any desired length.

Various changes and modifications to the embodiment herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. Metal stud manufacturing apparatus comprising:
a plurality of metal shaping rollers positioned to shape a continuous metal strip into continuous first and second metal panels each having first and second longitudinal edges turned to provide support along the longitudinal axis and to longitudinally cut or separate the first and second metal panels of the continuous strip into first and second spaced apart metal panels;
a pair of opposing wire shaping elements positioned to form a continuous wire into a continuous zig-zag pattern of wire;
an assembly component positioned to receive the continuous first and second spaced apart metal panels and the continuous zig-zag pattern of wire and to position the zig-zag pattern of wire between the spaced apart metal panels and in contact with one of the first and second longitudinal edges of each of the spaced apart metal panels to form a continuous beam assembly;
a welding component receiving the continuous beam assembly and spot welding the zig-zag pattern of wire to the one of the first and second longitudinal edges of each of the spaced apart metal panels to form a continuous fixed beam; and
a cutting component reciprocally mounted to receive the continuous fixed beam and to hold the continuous fixed beam at selected areas and to shear the continuous fixed beam at the selected areas to form a plurality of separate metal beams of a desired length.

2. Metal stud manufacturing apparatus wherein the zig-zag pattern of wire forms an angular metal coupling element positioned between the first and second spaced apart metal panels and bent to periodically and alternately contact the first and second spaced apart metal panels at contact points.

3. Metal stud manufacturing apparatus as claimed in claim 1 wherein the plurality of metal shaping rollers shape the first and second spaced apart metal panels to each provide an outwardly directed flat surface, and shape each first and second longitudinal edge turned to provide support of each first and second spaced apart metal panel to include at least one bend away from the outwardly directed flat surface.

4. Metal stud manufacturing apparatus as claimed in claim 3 wherein the plurality of metal shaping rollers provide a knurled surface on each of the outwardly directed flat surfaces of the first and second spaced apart metal panels.

5. Metal stud manufacturing apparatus as claimed in claim 1 further including a source of the continuous metal strip positioned to supply the continuous metal strip to the plurality of metal shaping rollers.

6. Metal stud manufacturing apparatus as claimed in claim 1 further including a source of the continuous wire positioned to supply the continuous wire to the pair of opposing wire shaping elements.

7. Metal stud manufacturing apparatus as claimed in claim 6 further including a wire straightening element receiving the continuous wire from the source and straightening the wire so that the wire extends along substantially a single continuous axis, the straightened wire being supplied to the pair of opposing wire shaping elements

8. Metal stud manufacturing apparatus as claimed in claim 7 wherein the wire straightening element includes a first plurality of rollers oriented in the horizontal plane to straighten out any bends in the wire parallel with the horizontal plane and a second plurality of rollers oriented in the vertical plane to straighten out any bends in the wire parallel with the vertical plane.

9. Metal stud manufacturing apparatus as claimed in claim 1 wherein the plurality of metal shaping rollers, pair of opposing wire shaping elements, the assembly component, the welding component, and the cutting component are designed to continuously move the continuous metal strip and the continuous wire through the apparatus at a continuous and fixed speed.

10. Metal stud manufacturing apparatus as claimed in claim 1 wherein the welding component includes a first pair of opposed electrically conductive wheels attached to receive a pulse of electricity at a selected time, one of the first pair of wheels being positioned in continuous contact with the one of the first and second longitudinal edges of one of the spaced apart metal panels and the other of the first pair of wheels being positioned to contact the zig-zag pattern of wire at a selected tip and at the selected time, and a second pair of opposed electrically conductive wheels attached to receive another pulse of electricity at another selected time, one of the second pair of wheels being positioned in continuous contact with the one of the first and second longitudinal edges of the other of the spaced apart metal panels and the other of the second pair of wheels being positioned to contact the zig-zag pattern of wire at another selected tip and at the another selected time.

11. Metal stud manufacturing apparatus as claimed in claim 1 wherein the plurality of metal shaping rollers are designed to form one of the first and second longitudinal edges of each of the spaced apart metal panels so as to each include a single ninety degree bend from an outwardly directed flat surface to form a side wall, and the welding component is positioned to spot weld the zig-zag pattern of wire to an inner surface of the side wall on each of the spaced apart metal panels.

12. Metal stud manufacturing apparatus comprising:
a source of a continuous metal strip;
a source of a continuous wire;
a plurality of metal shaping rollers positioned to shape the continuous metal strip into continuous first and second metal panels each having first and second longitudinal edges turned to provide support along the longitudinal axis spaced apart and to longitudinally cut or separate the first and second metal panels of the continuous strip into first and second spaced apart metal panels;
a pair of opposing wire shaping elements positioned to form the continuous wire into a continuous zig-zag pattern of wire;
an assembly component positioned to receive the continuous first and second spaced apart metal panels and the continuous zig-zag pattern of wire and to position the zig-zag pattern of wire between the spaced apart metal panels and in contact with one of the first and second longitudinal edges of each of the spaced apart metal panels to form a continuous beam assembly;
a welding component receiving the continuous beam assembly and spot welding the zig-zag pattern of wire to the one of the first and second longitudinal edges of each of the spaced apart metal panels to form a continuous fixed beam;
a cutting component reciprocally mounted to receive the continuous fixed beam and to hold the continuous fixed beam at selected areas and to shear the continuous fixed beam at the selected areas to form a plurality of separate metal beams of a desired length; and
the apparatus designed to continuously move the continuous metal strip and the continuous wire through the apparatus at a continuous and fixed speed.

13. Metal stud manufacturing apparatus as claimed in claim 12 further including a wire straightening element receiving the continuous wire from the source and straightening the wire so that the wire extends along substantially a single continuous axis, the straightened wire being supplied to the pair of opposing wire shaping elements

14. Metal stud manufacturing apparatus as claimed in claim 13 wherein the wire straightening element includes a first plurality of rollers oriented in the horizontal plane to straighten out any bends in the wire parallel with the horizontal plane and a second plurality of rollers oriented in the vertical plane to straighten out any bends in the wire parallel with the vertical plane.

15. Metal stud manufacturing apparatus as claimed in claim 12 wherein the zig-zag pattern of wire forms an angular metal coupling element positionable between the first and second spaced apart metal panels and bent to periodically and alternately contact the first and second spaced apart metal panels at contact points.

16. Metal stud manufacturing apparatus as claimed in claim 12 wherein the plurality of metal shaping rollers shape the first and second spaced apart metal panels to each include an outwardly directed flat surface, and shape each first and second longitudinal edge turned to provide support of each first and second spaced apart metal panel to include at least one bend away from the outwardly directed flat surface.

17. Metal stud manufacturing apparatus as claimed in claim 16 wherein the plurality of metal shaping rollers provide a knurled surface on each of the outwardly directed flat surfaces of the first and second spaced apart metal panels.

18. Metal stud manufacturing apparatus as claimed in claim 12 wherein the plurality of metal shaping rollers are designed to form one of the first and second longitudinal edges of each of the spaced apart metal panels so as to each include a single ninety degree bend from an outwardly directed flat surface to form a side wall, and the welding component is positioned to spot weld the zig-zag pattern of wire to an inner surface of the side wall on each of the spaced apart metal panels.

19. Metal stud manufacturing apparatus comprising:
a source of a continuous metal strip;
a source of a continuous wire;
a plurality of metal shaping rollers positioned to receive the continuous metal strip from the source and to shape the continuous metal strip into continuous first and second metal panels each having first and second longitudinal edges turned to provide support along the longitudinal axis, the plurality of metal shaping rollers shape the first and second spaced apart metal panels to each include an outwardly directed flat surface, to shape each first and second longitudinal edge turned to provide support of each first and second metal panel to include at least one bend away from the outwardly directed flat surface, the plurality of metal shaping rollers providing a knurled surface on each of the outwardly directed flat surfaces of the first and second spaced apart metal panels, and to cut or separate the first and second metal panels into first and second spaced apart metal panels;
a wire straightening element positioned to receive the continuous wire from the source and including a first plurality of rollers oriented in the horizontal plane to straighten out any bends in the wire parallel with the horizontal plane and a second plurality of rollers oriented in the vertical plane to straighten out any bends in the wire parallel with the vertical plane;
a pair of opposing wire shaping elements positioned to receive the straightened continuous wire from the wire straightening element and to form the straightened continuous wire into a continuous zig-zag pattern of wire, the zig-zag pattern of wire forming an angular metal coupling element positionable between the first and second spaced apart metal panels and bent to periodically and alternately contact the first and second spaced apart metal panels at contact points;
an assembly component positioned to receive the continuous first and second spaced apart metal panels and the continuous zig-zag pattern of wire and to position the zig-zag pattern of wire between the spaced apart metal panels and in contact with one of the first and second longitudinal edges of each of the spaced apart metal panels to form a continuous beam assembly;
a welding component receiving the continuous beam assembly and spot welding the zig-zag pattern of wire to the one of the first and second longitudinal edges of each of the spaced apart metal panels to form a continuous fixed beam;
a cutting component reciprocally mounted to receive the continuous fixed beam and to hold the continuous fixed beam at selected areas and to shear the continuous fixed beam at the selected areas to form a plurality of separate metal beams of a desired length; and
the apparatus designed to continuously move the continuous metal strip and the continuous wire through the apparatus at a continuous and fixed speed, the cutting component being designed to reciprocally move with the continuous fixed beam at the fixed speed to perform the shear cutting at a selected cutting area and after the shear cutting reciprocating to the next cutting area.

20. Metal stud manufacturing apparatus as claimed in claim 19 and further including a control panel designed and connected to control at least the fixed speed of the apparatus.

21. Metal stud manufacturing apparatus as claimed in claim 19 wherein the welding component includes a first pair of opposed electrically conductive wheels attached to receive a pulse of electricity at a selected time, one of the first pair of wheels being positioned in continuous contact with the one of the first and second longitudinal edges of one of the spaced apart metal panels and the other of the first pair of wheels being positioned to contact the zig-zag pattern of wire at a selected tip and at the selected time, and a second pair of opposed electrically conductive wheels attached to receive another pulse of electricity at another selected time, one of the second pair of wheels being positioned in continuous contact with the one of the first and second longitudinal edges of the other of the spaced apart metal panels and the other of the second pair of wheels being positioned to contact the zig-zag pattern of wire at another selected tip and at the another selected time.

22. Metal stud manufacturing apparatus as claimed in claim 19 wherein the plurality of metal shaping rollers are designed to form one of the first and second longitudinal edges of each of the spaced apart metal panels so as to each include a single ninety degree bend from an outwardly directed flat surface to form a side wall, and the welding component is positioned to spot weld the zig-zag pattern of wire to an inner surface of the side wall on each of the spaced apart metal panels.
